(19) United States
(12) Patent Application Publication
(10) Pub. No.: US 2006/0093797 A1
(43) Pub. Date: May 4, 2006

(54) Decoration of articles and wares

(76) Inventor: Henry Sawatsky, Oliphant (CA)

Correspondence Address: D.W. EGGINS, 18 DOWNSVIEW DRIVE, BARRIE, ON, L4M 4P8, CA

(21) Appl. No.: 11/302,238

(22) Filed: Dec. 14, 2005

Related U.S. Application Data
(63) Continuation-in-part of application No. 10/765,054, filed on Jan. 28, 2004.
(63) Continuation-in-part of application No. 10/046,743, filed on Jan. 17, 2002, now Pat. No. 6,699,352.

(51) Int. Cl. B41M 5/00

(52) U.S. Cl. 428/195.1

(57) ABSTRACT

Successive Digital Ink Jet printing heads decorate ceramic/glass and other wares; for ceramics/glassware an adhesion-promoting coating material is DIJ-applied on the print site; a DIJ-printable coating is overlaid, followed by a DIJ-applied background colour, the required decoration is DIJ-applied on the area, and a protective transparent coating is then DIJ-overlaid. Most layers are cured/dried with U/V and/or I/R and/or Hot-air. Successive impact-protective layers can be DIJ printed. Other DIJ-printed wares include flat ware, metal-ware, pens, markers and pencils, DVD and CD discs, which wares may not require adhesion promoting material or printable under-coating. The work stations may overlie one or more carousels which transport the wares.

### CROSS REFERENCE TO RELATED APPLICATIONS

This application is a Continuation-in-Part of applications Ser. Nos. 10/046,743, filed Jan. 17, 2002, and 10/765,054 filed Jan. 28, 2004, which are incorporated herein, by way of reference.

### STATEMENT REGARDING FEDERALLY SPONSORED RESEARCH OR DEVELOPMENT

N/A (Not Applicable).

### REFERENCE TO MICROFICHE APPENDIX

N/A

### BACKGROUND OF THE INVENTION

1. This invention is directed to systems for applying specialty coatings to objects, generally in a range of small and intermediate sizes. The system applies in particular to the application of decorative and/or protective coatings to a range of articles. The coatings may form part of a further process, or they may be final coatings.

2. The application of decorative and protective coatings on items such as drinking glasses and like wares has previously utilized coating processes employing dip coating, and air brushing, while the application of decoration and/or printed matter for large scale production has utilized screen and pad printing.

### BRIEF SUMMARY OF THE INVENTION

It has been found that recent improvements in the printheads used for DIJ (Digital Ink Jet) printing, in addition to providing excellent colour imaging, also enables use of DIJ printing for the application of non-decorative coatings, including basic undercoats and protective overcoats to a wide range of articles.

The accuracy and detail now associated with updated DIJ printing enables the use of computerized control for the application of precise thickness coatings to precisely pre-planned surface areas on a range of wares.

In the present invention, in the case of glass and ceramic wares, the surface of the wares is DIJ-printed with an adhesion promoter (Adpro) which bonds by chemical reaction to the surface of the glass and ceramics. A urethane is DIJ-applied over the Adpro whereat a chemical reaction takes place between the Adpro and the urethane, creating a chemical bond.

The use of DIJ_printing for the application of these non-decorative preliminary coatings has resulted from the development of modification to the viscosity of the adhesion promoter and the urethane, to enable proper functioning of the DIJ print heads The range of thickness, at least in the case of urethane, provided by DIJ printing is from 0.01 mm to 1.0 mm per pass, so that greater thicknesses, if required, can be built up to the desired extent by the use of multiple print heads arranged in serial relation, usually with an intervening drying/curing step.

In the case of protective outer coatings, such greater thicknesses may be required for breakage resistance, as in the case of drinking glasses.

The range of wares to which the subject process may be applied, in addition to glass and drinkware includes Digital Video Discs (DVD's),and wares such as pens and similar promotional items of plastic, and metal ware such as coffee mugs, medallions and flatware.

In the case of the metal wares, an adhesion promoter is not required, as the urethane printing surface material adheres very well to metals.

In comparing the present invention with the prior state-of-the-art, the application of coatings and inks by DIJ printing heads greatly reduces the amount of the materials being used, and the adoption of carousel work stations greatly shortens the length of the production line, with significantly reduced space requirements. In the case of the decoration of ceramics and glasswares, overall cost savings of as much as 50% are confidently anticipated

In decorating wares by way of DIJ printing, owing to the extremely thin coatings that are applied, it is necessary in almost all instances to apply a background coating of white. The white background undercoat is also necessary to ensure achieving a predictable colour when applying any of the usual primary process colours.

In the subject system, this white undercoat is first applied by DIJ printing, to ensure that the comparatively transparent DIJ-printed colours that are subsequently applied, adhere in consistent, predictable fashion. The white undercoat is applied in two successive thin coatings, with individual U/V drying/curing of each coating.

The creation of a white urethane ‘ink’ undercoat, for application by DIJ printing is contemplated, wherein the characteristics of existent white ink are combined with those of the urethane coating of the present invention that is DIJ-printed to receive the currently used white undercoat. This combined coating will then obviate the need for a urethane coat overlying the adhesion promotion layer, and the succeeding separately-applied white undercoat, as taught above.

In order to achieve rapid, production-line operation that can compete economically with existing prior art line processes, it is necessary to make drying/curing provisions at a series of locations, between serial batches of DIJ printheads. And in order that the spatial requirements for the subject systems are not unduly extended, it is important, even imperative that such curing provisions shall be very effective and high rate. To that end, selection is made between U/V, I/R and Hot-Air drying/curing. In some instances spatial requirements may be minimized by applying the final cure/drying step on the linear unloading conveyor.

As regards the use of U/V drying for drinkware due attention must be paid to federal and local health regulations

Urethane forms an ideal base coat for DIJ printing, and its viscosity is modified to suit DIJ print-heads by regulating the proportion of thinners used.

For the adhesion promoter coating, this adjustment is effected by thickening with a water soluble cellulose to a viscosity that is appropriate for jetting by the subject printhead. The applied urethane base coat is usually undercured to enhance adhesion to it by the immediately next applied coating, usually of white ink. This undercoat is then dried/cured.

The desired decorative/textual material is then applied by way of DIJ printing, and if required a protective clear urethane overcoat can then be applied, again by DIJ printheads. A major advantage afforded by the present invention is the use of digitally-controlled printers, which greatly affects the speed at which changes can be effected in the controlling program, in both the position and form of the area to be protected and/or decorated on a run of articles, and in the details of the decoration being applied.

These details, being pre-planned, and programmed into a controlling computer, can then be substantially instantaneously transferred to the DIJ apparatus of the production line, thereby making possible a virtually instantaneous line change, for all the necessary DIJ-based application (coating and printing) steps of the process.

For instance, promotional ‘give-aways’ such as ball-point pens can receive an immediate change-over in the decorative style, size and the identity of the sponsor, as applied by the subject system.

Adjustment to the viscosity of the adhesion promoter and its urethane undercoat enables the DIJ jetting (i.e. ‘printing’) of these non-ink liquids.

In selecting the curing mode for the coatings, with particular regard to the curing of urethane, while U/V curing of urethane is extremely rapid, consideration must be given to any related governmental restrictions. I/R curing is more rapid than Hot-air curing, with associated cost savings in both space and plant provisions.

The present invention provides a method of coating a surface portion of an article, including the steps of positioning the article in a predetermined attitude upon a transport means at a first location; moving the article into working proximity to a first Digital Ink Jet printing means; applying a first coating by the first printing means to a predetermined first surface area of the article; moving the article to a second DIJ printing means, and applying a second coating to a second, predetermined area of the article; and curing at least one of these coatings by exposure to curing means selected from the group consisting of U/V, I/R and Hot-air. The first and second areas may be substantially coincident.

In applying the steps of the subject process, significant capital savings in terms both of building space and ancilliary fittings (such as mandrels and their associated drive motors) are made possible by the adoption of a carousel format as the working transfer medium between successive work stations. Also, with the adoption of a carousel format, the loading and unloading functions from/to linear conveyors can be carried out at sensibly the same location, thereby localizing and minimizing labour requirements.

The adoption of a carousel format can include the use of multi tier carousels, incorporating tier-to-tier transfer assemblies wherein work processes that require significantly larger space provisions can be carried out on one tier, and more compact process steps can be carried out on another tier. Also, the(upper v-s lower) tier selection for larger space processes v-s compact processes can be based upon the physical characteristics associated with the respective tier process requirements, such as the provision of hoods with external ventilation.

As an example, in a process for printing drinking mugs in accordance with the present invention, wherein DIJ printing of various appliques constitute a series of successive, compact process steps, as contrasted with space-extended process steps of curing and drying, with subsequent cooling, the compact process steps can all be carried out on a carousel at a first level, and the space-extended process steps can be carried out on a carousel at a second level.

The curing/drying, and cooling process steps all benefit from significant amounts of head-room, so that the second level is advantageously positioned above the first carousel level, with transfer assemblies provided to effect the necessary product transfers, from tier to tier, both up and down.

Although the operation of the two carousel levels are integrated, the carousels may index from station to station at respectively different speeds. This also has a bearing on desired station dwell times, for carrying out the respective process step.

As a for-instance: with drinking mugs, mounted on rotatable chuck-holder assemblies on the lower tier carousel, being imprinted with adhesion promoter (AdPro), they are successively transferred by up-transfer to the upper tier to a drying/curing and cooling tunnel.

On completion of the drying/curing, and cooling cycle, a ‘down’ transfer mechanism operates to return the dried/cured and cooled mugs to their original holder assemblies on the lower carousel. In one embodiment, the upper and lower tiered carousels rotate in mutually opposed directions, to facilitate phased operation of the carousals, in their step-by-step rotation.

### BRIEF DESCRIPTION OF THE SEVERAL VIEWS OF THE DRAWINGS

Certain embodiments of the invention are described by way of illustration, without limitation thereto other than as set forth in the accompanying claims, reference being made to the accompanying drawings, wherein:

FIG. 1 is a schematic plan view of a process line for carrying out the coating of articles in accordance with the present invention;

FIG. 2 is a schematic block diagram showing an example of some of the subject process steps, as applied to one class of articles;

FIG. 3 is a sketch illustrating the stages in production of a Digitally Ink Jet—coated and decorated article;

FIG. 4 is a schematic plan view arrangement detailing a typical work-station arrangement associated with a carousel organization for coating and printing ceramic and glassware;

FIG. 5 is a view similar to FIG. 4 of a carousel organization for pens, pencils and markers;

FIG. 6 is a schematic perspective representation of portions of a pair of stacked carousels, with a transfer mechanism; and,

FIG. 7 is a schematic perspective view of an upper carousel with a drying/curing and cooling tunnel.

### DETAILED DESCRIPTION OF THE INVENTION

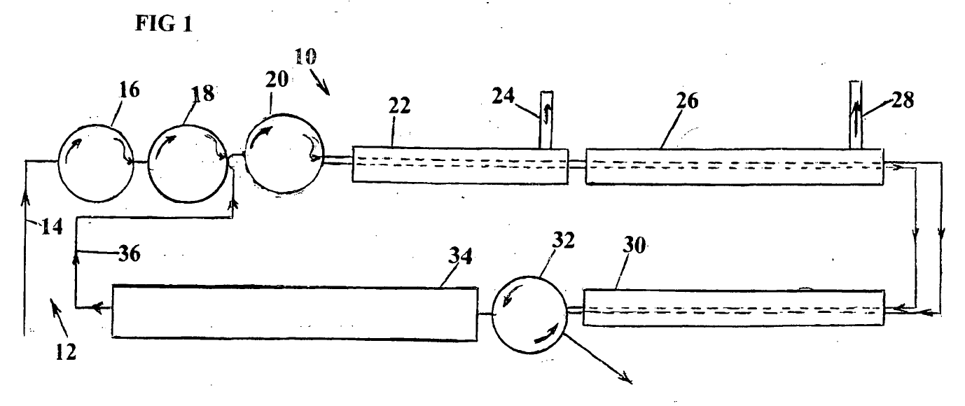

The present disclosure is made by way of example, without limitation of the invention thereto, it being understood that changes and modifications thereto may be readily accomplished by persons skilled in the art, within the scope of the present claims. Referring to FIG. 1, a production line 10 has a loading area 12 at which wares of a selected type are loaded onto a conveyor 14.

In the case of hollow wares such as drinking glasses or mugs they are suspended in an inverted position from vacuum fittings.

The conveyor 14 transfers the wares to a first Digital Ink Jet (DIJ) printing station 16, where a layer of adhesion promoter is DIJ-applied to a pre-determined surface area or areas, and then passed to a dryer 18, where the adhesion promoter is cured (i.e. dried) with a flow of warm air, or by Ultra Violet or Infra Red radiation, or combinations thereof.

The wares are then transferred to the next DIJ printing station 20, while still in t their indexed position, and a layer of urethane DIJ printed over that same treated area. The wares then are transferred to drying tunnel 22, and travel at a predetermined line speed through the tunnel 22 while being exposed to a curing environment of U/V, I/R or H/A_(hot air), during a residence time sufficient to cure the urethane to the desired extent. In many instances the cure is only partial, in order to enhance bonding of the succeeding downstream DIJ application of base-colour. The warm air and out-gas by-products of the curing pass to a vent 24.

The conveyor 14 with its load of vessels continues on into a heated tunnel 26, travelling at a predetermined speed to achieve a desired heat exposure within the tunnel 26 to cure the coating. The curing tunnel 26 is vented at vent 28.

The vessels then continue on the conveyor 14 to a cooling tunnel 30 where they are brought to ambient temperature with a flow of ambient air. At this point each vessel is DIJ printed with a very thin, uniform printable coating of almost immeasurable thickness.

The vessels now pass to a collection table 32, for passage through a printing or other decorative process. In the above-identified process, Digital Ink Jet (DIJ) printing is used, and in the present preferred embodiment DIJ printing means 34, consisting of one or more DIJ printing machines enables the application to the vessels of decoration having four or five colours.

The speed of the entire line 10 is controlled, with the speed of conveyor 14 being tied to the speed of the DIJ printing means 34.

Leaving the printer 34, the now-printed (i.e.. decorated) units travel by way of conveyor 36 to rejoin the line 10 at a location upstream of the DIJ printer 20, for a protective urethane coating, which is dried and cured on the line 10, and the articles taken from the collection table 32 for inspection and packaging.

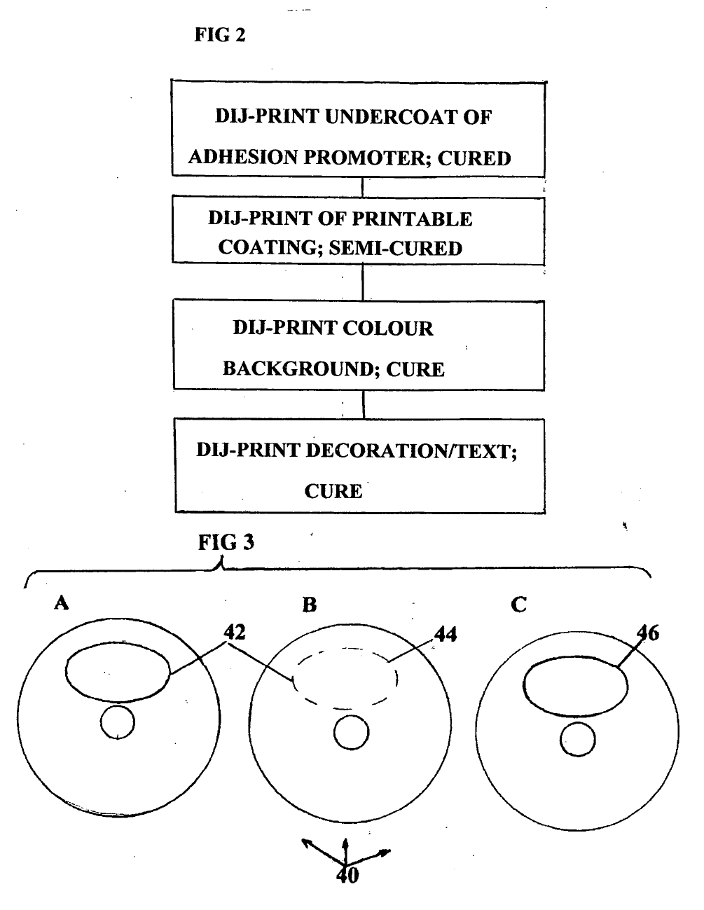

Turning to FIG. 2, which relates to articles that require an adhesion promoter and a urethane undercoat, the articles to be decorated are loaded in predetermined indexed relation onto a conveyor, at a predetermined rate, and transferred to a first DIJ printing station, where an undercoat of adhesion promotion material is printed onto the area that is to be ‘decorated’. This material is then cured by U/V, I/V or H/A.

The article, on arriving at the second DIJ printing station, receives a thin coating of urethane printed over the decorated area, in transparent, protective relation.

It will be understood in the context of the present invention that “decorate”, “decoration” and versions of that word refer to the application of artwork and also to textural matter that may be imprinted upon articles that are subject to the process.

Describing FIG. 2 in more general terms:
1) adhesion promoting coating is first DIJ-applied and cured
2) printable coating DIJ-applied, cured/semi-cured and cooled;
3) colour background DIJ-applied and cured;
4) decoration applied over colour background by DIJ-printing and cured

It will be understood that a protective transparent overcoating isapplied in some instances, and omitted in the case of some wares. It is not illustrated in this instance. The steps of product inspection and packaging have also been omitted from FIG. 2 Turning to FIG. 3, a disc 40, such as a DVD or CD is shown in two successive stages, A and B.

In stage A, a discrete area 42 receives a first, DIJ printed (white background) undercoat, which is dried, and cured.

In stage B, the background area 42 (now shown in dashed lines) receives a DIJ-applied decoration 44, such as a combination of art-work and text, selected from a plurality of primary colours and precisely superimposed on the white background area 42.

In an optional stage C, the area 44 may be overlaid by a DIJ-applied transparent protective over-coating 46, which substantially coincides with the area 42 of the first and second coatings. However, this optional stage C is unlikely to be used for DVD's or CD's.

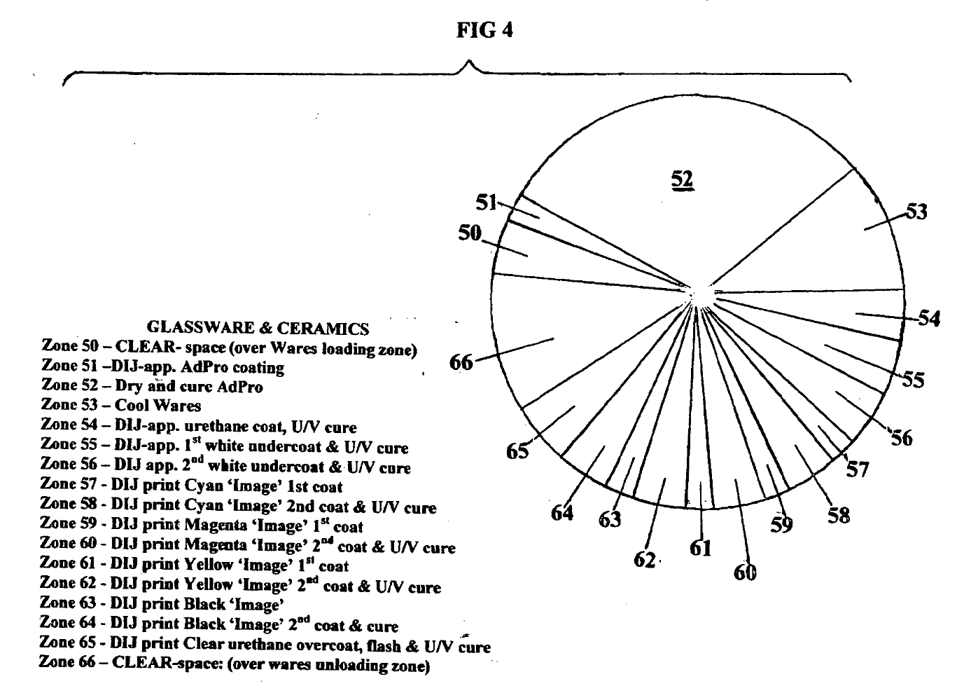

Turning to FIG. 4, the pattern of workstations arranged above a carousel is shown for the coating and printing of ceramics and glassware.

(The illustrated workstation arrangement does not include the building up of accumulated thickness urethane impact-protective layers, of which the process is capable) Located beneath the fixed workstations is a rotatable carousel (not shown), the working surface of which contains the requisite fittings of mandrels and their associated drive motors, upon which the glass and ceramic hollow-wares are mounted, for the carrying out of the process steps at the respective workstations.

The respective work-station zone segments 50 through 66 are of differing sizes, in accordance with the respective desired residence time therebeneath of the carousel, and the physical space required to accommodate the associated process-applying device, such as DIJ printing heads, and drying/curing/cooling apparatus.

The process zones are described in terms of their function:
Zone 50—CLEAR:-space above Wares loading zone (individual transfer of wares from a linear belt conveyor (not shown) to mandrels mounted on the carousel)
Zone 51—Digital Ink Jet (DIJ) apply adhesion promoter (AdPro) coating
Zone 52—Dry and cure AdPro coating (I/R)
Zone 53—Cool wares with ambient air circulation
Zone 54—DIJ apply clear urethane coat (flash) and U/V cure
Zone 55—DIJ apply first white undercoat and U/V cure
Zone 56—DIJ apply second white undercoat and U/V cure
Zone 57—DIJ print Cyan ‘Image’ first coat
Zone 58—DIJ print Cyan ‘Image’ second coat and U/V cure
Zone 59—DIJ print Magenta ‘Image’ first coat
Zone 60—DIJ print Magenta ‘Image’ second coat and U/V cure
Zone 61—DIJ print Yellow ‘Image’ first coat
Zone 62—DIJ print Yellow ‘Image’ second coat and U/V cure
Zone 63—DIJ print Black ‘Image’
Zone 64—DIJ print Black ‘Image’ second coat and cure
Zone 65—DIJ print Clear urethane overcoat, flash and U/V cure
Zone 66—CLEAR: individual wares transfer from mandrels to conveyor

The underlying carousel, over which the seventeen process zones are located, has a circumference of fifty feet, and is driven by a computer controlled stepping motor, moving at the rate of one foot per second at its periphery, as it moves successively zone to zone. Zone 51 has a dwell time of one second, while in contrast, Zone 52 has a dwell time of fifteen seconds.

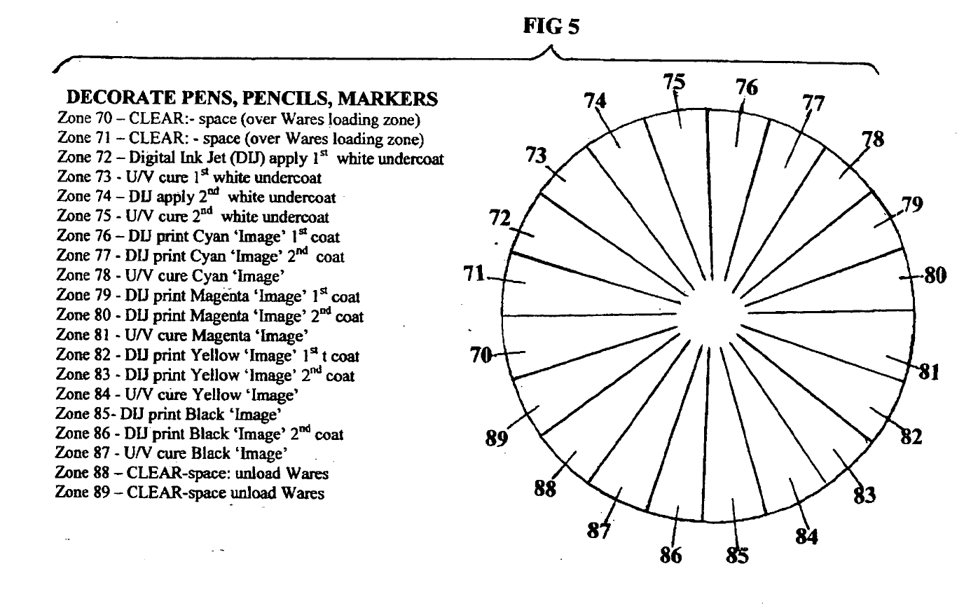

This example and that of FIG. 5 are typical sequences, which can be varied: colour sequences may vary, and UN curing may be carried out more frequently or less frequently in order to control the sharpness of the image

Turning to FIG. 5, the pattern of workstations arranged above a carousel is shown for the coating and printing of pens, pencils and markers.

Located beneath the fixed workstations is a rotatable carousel (not shown), the working surface of which contains the requisite fittings to receive and position the cylindrical small wares, for the carrying out of the process steps at the respective workstations.

The respective work-station zone segments 70 through 89 are of substantially uniform size, having the necessary physical space required to accommodate the associated process, such as manual loading and unloading, and process-applying devices, such as DIJ printing heads, and drying/curing/cooling apparatus.

The process zones are described in terms of their function:
Zone 70—CLEAR:-space above Wares loading zone (for individual transfer of wares from conveyor (not shown) to carousel-mounted fittings)
Zone 71—CLEAR:-space above Wares loading zone
Zone 72—Digital Ink Jet (DIJ) apply first white undercoat
Zone 73—U/V cure first white undercoat
Zone 74—DIJ apply second white undercoat
Zone 75—U/V cure second white undercoat
Zone 76—DIJ print Cyan ‘Image’ first coat
Zone 77—DIJ print Cyan ‘Image’ second coat
Zone 78—U/V cure Cyan ‘Image’
Zone 79—DIJ print Magenta ‘Image’ first coat
Zone 80—DIJ print Magenta ‘Image’ second coat
Zone 81—U/V cure Magenta ‘Image’
Zone 82—DIJ print Yellow ‘Image’ first coat
Zone 83—DIJ print Yellow ‘Image’ second coat
Zone 84—U/V cure Yellow ‘Image’
Zone 85—DIJ print Black ‘Image’
Zone 86—DIJ print Black ‘Image’ second coat
Zone 87—U/V cure Black ‘Image’
Zone 88—CLEAR: individual wares transfer from mandrels to conveyor
Zone 89—CLEAR: individual wares transfer from mandrels to conveyor

The underlying carousel, over which the nineteen process zones are located, is in the order of four feet in diameter. A computer controlled stepping motor, moves the carousel stepwise successively from zone to zone.

The respective zone dwell times for the carousel are programmed in accordance with the process time requirements for that zone.

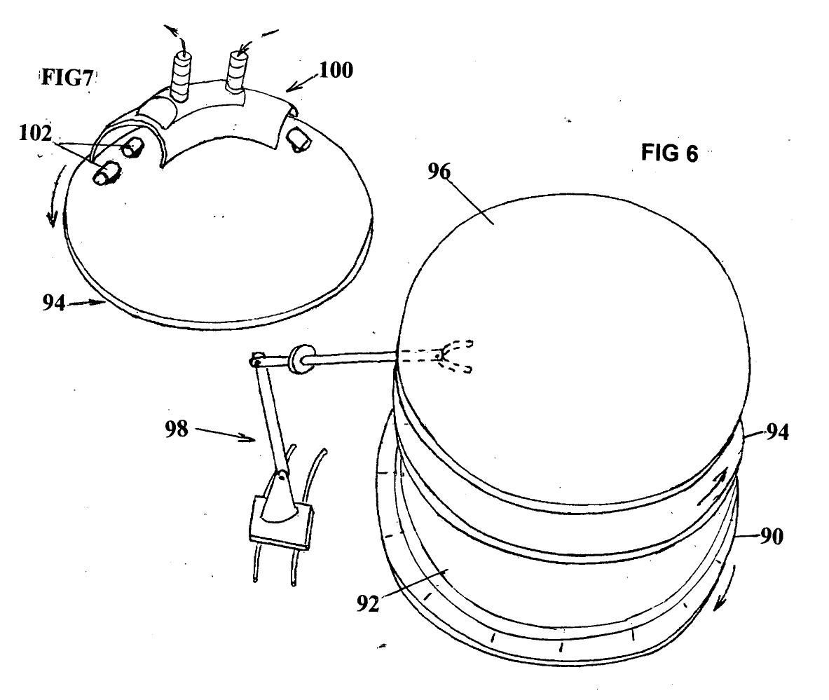

Turning to FIG. 6, a first (lower) rotatable carousel 90 is located beneath an annular stationary array 92 of workstations, in the fashion of the FIG. 4 illustration.

A second (upper ) rotatable carousel 94 has a stationary cover 96, which supports drying/curing apparatus (see FIG. 7).

In the illustrated embodiment, the upper carousel 94 rotates in a direction opposed to that of lower carousel 90.

A track-mounted, digitally controlled “pick'n place” transfer/re-positioning robot 98 is shown, for transferring wares from the first carousel 90 for re-positioning upon the second carousel 94. It will be understood that at least two such “pick'n place” transfer robots 98 will usually be provided, one for upward transfer of the wares, and a second for downward return of the wares to the lower carousel 90 for further DIJ printing operations. In carrying out these operations the robot 98 is programmed to deposit the wares (illustrated as drinking mugs) in precisely oriented relation, in registry with the process-applying apparatus. In the case of the illustrated mugs, the mug handles may serve as the referenced positioning datum.

In FIG. 7, a representation of carousel 94 (to a different scale) is shown, having a drying/curing and cooling tunnel 100 suspended from cover 96, through which tunnel 100 the “printed” wares 102 pass, and are dried/cured, and cooled.

1. The method of coating a surface portion of an article, including the steps of positioning said article in a predetermined attitude upon a transport means at a first location; moving the article into working proximity to a first Digital Ink Jet printing means; applying a first coating by the first printing means to a predetermined first surface area of the article; moving the article to a second DIJ printing means, and applying a second coating to a second, predetermined area of the article; and curing at least one said coating by exposure to curing means selected from the group consisting of U/V, I/R and Hot-air.

2. The method as set forth in claim 1, wherein said second surface area is substantially coincident with said first surface area.

3. The method as set forth in claim 1, wherein said first coating is an adhesion promotion material, and said second coating is a printable coating.

4. The method as set forth in claim 1, including moving said article to a third DIJ printing means, and DIJ printing over said second coating a DIJ-print colour background.

5. The method as set forth in claim 4, including moving said article to a fourth DIJ printing means, and DIJ-printing decorative material over at least a portion of the area of said colour background.

6. The method as set forth in claim 5, including moving said article to a fifth DIJ printing means, and DIJ-printing a transparent protective coat over at least a portion of said decorative material.

7. The method as set forth in claim 1, wherein one said coating is a urethane-based coloured ink undercoat to provide a DIJ-print colour background for over-printing.

8. The method as set forth in claim 7, wherein said over-printing is DIJ-applied decorative material.

9. The method as set forth in claim 8, including applying a third, transparent protective coating over at least a portion of said decorative material.

10. A decorated product having a DIJ decoration applied to a predetermined surface area of the product, including: an adhesion promoting first coating applied to at least a predetermined area to be decorated; a second, printable coating DIJ applied at least to said predetermined area to be decorated; and a DIJ-applied decoration applied to said second coating.

11. The product as set forth in claim 10, further including a substantially transparent outer, protective coating, DIJ-applied in overlying, protective relation with said decoration.

12. The product as set forth in claim 11, wherein said substantially transparent outer, protective coating is DIJ applied and covers said decoration.

13. The product as set forth in claim 11, wherein said substantially transparent outer, protective coating is DIJ applied and covers a major surface portion of said product.

14. A decorated product as set forth in claim 10, wherein a white undercoat is DIJ applied to said predetermined surface area; a first colour portion of said decoration is DIJ applied on said undercoat; and at least one further colour coat is DIJ applied in predetermined positioned relation with said first colour portion of said decoration.

15. The product as set forth in claim 14 wherein said DIJ decoration includes a plurality of basic colours.

16. Apparatus for decorating hand-portable wares, comprising first transport means for moving said wares; transfer means for receiving said wares in mutually spaced relation thereon; said transfer means moving in a predetermined arcuate path and having a plurality of overhead digital ink jet printing heads in mutually spaced relation along said path, wherein at least one said printing head is adapted to deposit a thin, non-decorative layer upon a predetermined surface portion of said wares by discrete jet application; and another said printing head is adapted to deposit at least one decorative layer upon at least a portion of said predetermined surface portion of said wares; and drying/curing means positioned adjacent said transfer means, to dry/cure said layers on said wares.

17. The apparatus as set forth in claim 16, wherein said transfer means consists of at least one rotatable carousel.

18. The apparatus as set forth in claim 16, wherein said transfer means consists of a first, lower level carousel and a second upper level carousel located in superposed relation over said first carousel; and transfer re-positioning means for transferring said wares between said levels.

19. The apparatus as set forth in claim 18, wherein said first and said second carousels rotate step-by-step in predetermined, mutually scheduled relation, for sequential, step-by-step decoration of said wares.

20. The apparatus as set forth in claim 18, wherein said first and said second carousels rotate in mutually opposed directions.
